(19) United States
(12) Patent Application Publication
(10) Pub. No.: US 2011/0014589 A1
(43) Pub. Date: Jan. 20, 2011

(54) METHOD FOR MAKING A DENTAL BLANK, A PRESS AND A SYSTEM FOR MAKING DENTAL BLANKS

(76) Inventors: Holger Hauptmann, Sindelsdorf (DE); Robert Schnagl, Jengen (DE); Martin Goetzinger, Eching a. Ammersee (DE); Marc Peuker, Schondorf (DE); Andreas Gericke, Landsberg am Lech (DE); Stefan Hoescheler, Munich (DE)

Correspondence Address: 3M INNOVATIVE PROPERTIES COMPANY, PO BOX 33427, ST. PAUL, MN, 55133-3427, US

(21) Appl. No.: 12/922,925

(22) PCT Filed: Mar. 13, 2009
(86) PCT No.: PCT/US09/37106

§ 371 Date: Sep. 16, 2010

(30) Foreign Application Priority Data
Mar. 19, 2008 (GB) 0805052.8

(51) Int. Cl. A61C 13/08; B30B 9/28

(52) U.S. Cl. 433/201.1; 100/193; 433/215

(57) ABSTRACT

The invention relates to a method of making a dental blank which combines uniaxial pressing isostatic pressing techniques. The invention also includes a press for performing the method and a system comprising a uniaxial and a isostatic press. The invention may help in efficient manufacturing of dental blanks at minimized costs and maximized quality.

### CROSS-REFERENCE TO RELATED APPLICATIONS

This application claims priority to United Kingdom Patent Application No. 0805052.8 filed Mar. 19, 2008.

### FIELD OF THE INVENTION

The invention relates to a method for making a dental blank of a ceramic material, as typically used for making dental restorations. The invention also relates to a press and a system for making dental blanks.

### BACKGROUND OF THE INVENTION

Dental restorations are often made of ceramic materials because ceramic materials generally provide relatively good physical, aesthetic and biological properties as commonly desired in the field of dentistry. Examples of such dental restorations are crowns, bridges, inlays, onlays, veneers, implants. One way to make dental restorations of ceramic materials includes the use of an automated process, in which a dental restoration precursor is machined from a ceramic blank. A type of blank as it is typically used in such process is made of pressed and pre-sintered ceramic particles. Relative to the use of a solid ceramic material, a so formed dental blank is porous and relatively soft so that it can be machined relatively easily. On the other hand such blank is sufficiently stable so that it can be handled in a machine.

Dental blanks for making dental restorations may be formed by pressing ceramic particles, like a ceramic powder, at relatively high pressure so that the ceramic particles block with each other and form a generally cohesive body of material. A subsequent pre-sintering step typically adds further mechanical stability to the body and thereby forms the dental blank which can then be used for producing a dental restoration precursor.

A dental restoration precursor obtained from such pressed and pre-sintered blank is typically further sintered, and subsequently polished or furnished with a veneer. Typically the precursor shrinks, generally proportionally, during sintering because the initially porous material reduces in porosity and increases in density. For this reason the restoration precursor may be initially larger, for example about 20% to 30% in each dimension, than the desired final shape after sintering, to account for shrinkage during the sintering step. It has been found desirable that the material structure of the blank is of a generally uniform density. This is because a non-uniform density or inhomogeneity of the blank material may cause the dental restoration precursor obtained from that blank to shrink non-uniformly in one or more dimensions during sintering. Thus, the precision of the final dental restoration may be adversely affected, resulting in wasted time and expense for a dentist.

To achieve a relatively uniform density of the blanks the ceramic particles are often pressed by isostatic pressing techniques. Isostatic pressing typically is based on the use of a hydraulic fluid, for example oil, water or an emulsion of both, to apply pressure to the ceramic particles generally uniformly from all sides, or isotropically. Typically isostatic pressing is used with cylindrical blanks because the cylindrical shape provides for relatively isotropic compaction, and therefore provides for a relatively homogeneous inner structure of such blanks However, there have been efforts to find alternative pressing techniques that are less expensive, and/or which can be reliably used for different blank shapes.

SE-7807661 describes a tool for isostatic pressing. The tool has an upper and a lower tool component which can be combined to form a mold. Each of the tool components have a membrane which join to form a closed space within the mold when the tool components are combined. A material to be pressed may be accommodated in the space between the membranes. Each of the tool components provide for a pressure medium to be supplied between the mould walls and the outside of the membranes, so that the pressure medium can be used to pressurize the membranes for pressing of the material accommodated in between.

It is still desired to manufacture blanks having any desired shape with a consistently high degree of homogeneity of the inner material. Also, it is a general desire to provide a relatively inexpensive manufacturing process. Especially for dental purposes there is also demand for a manufacturing process that provides for maintaining a high hygiene level during production.

### SUMMARY OF THE INVENTION

The invention provides a method, a press and a system for making a dental blank. Preferably the dental blank is comprised of ceramic particles of a ceramic material based on zirconium or aluminum oxide. The dental blank is preferably usable in the preparation of dental restorations.

According a first aspect, the invention provides a method of making a dental blank. The method comprises the steps of:

(a) pressing ceramic particles to form a dental blank precursor; and

(b) pressing the dental blank precursor to form the dental blank,

wherein one of the steps (a) and (b) includes uniaxial pressing and the other one of the steps (a) and (b) includes isostatic pressing. Preferably the step (b) includes isostatic pressing. Step (a) accordingly preferably includes uniaxial pressing.

The method preferably provides at least to some extent for independent controlling of the general shape, and the material homogeneity of the dental blank. For example, one pressing step may be adapted and/or controlled to achieve a relatively precise general shape of the blank. In a subsequent pressing step may be adapted and/or controlled to increase the material homogeneity of the blank, preferably without substantially changing the shape of the blank. This may be advantageous because relative to a single continuous process the invention preferably allows splitting of the blank manufacturing process into separate steps, each allowing the application of appropriate parameters (for example pressures, pressing speeds etc.), and the use of appropriate tooling. The invention, for example, may provide for pre-shaping blanks in a relatively easy, robust and inexpensive process. The so formed blank precursors may be subsequently increased in their material homogeneity rather effectively in a process that would probably be less effective in shaping. The invention may therefore provide for minimizing the overall process time required for making dental blanks. Further the invention may provide for a relatively homogeneous inner material structure of the dental blanks independently from their shape. The invention may also provide a cost effective method of making blanks, and further may provide for dental blanks to be manufactured at relatively high quality.

Preferably uniaxial and isostatic pressing are only used separate from each other. For example, isostatic pressing may only be performed when uniaxial pressing is inactive. Further uniaxial pressing may only be performed when isostatic pressing is inactive. In particular the step (a) may comprise a step of releasing the dental precursor from pressure. Therefore the material of the dental blank precursor may relax between steps (a) and (b). For example, the material density of the dental blank precursor may decrease during relaxation. This may provide for a better material homogeneity of the dental blank in the step (b).

Preferably uniaxial pressing comprises pressing of the ceramic particles or the dental blank precursor from generally mainly opposite sides, for example two opposite sides, preferably by moving at least two pressing dies towards one another. Preferably such two pressing dies during pressing also move relative to a die plate which laterally restrains the ceramic particles or the dental blank precursor.

During step (b) “pressing the dental blank precursor to form the dental blank” the dental blank precursor is preferably in touch with a pressing member. The pressing member is preferably arranged between the dental blank precursor and a hydraulic fluid. Further the pressing member preferably transmits pressure received from the hydraulic fluid to the dental blank precursor. The pressing member is preferably adapted to generally conform to the shape of at least a portion of the dental blank precursor. This also includes that the pressing member is adapted to generally conform to a shape change of the portion of the dental blank precursor. Such change of the shape may, for example, result from a compression of the dental blank precursor during the step (b). Therefore the pressing member is preferably also adapted to generally conform to the shape of a portion of the dental blank. The pressing member is preferably flexible or deformable. In particular the pressing member may be a membrane, preferably a flexible membrane.

Preferably the general shape of the dental blank is mainly provided by the step (a) “pressing ceramic particles to form a dental blank precursor”. In contrast, the dental blank preferably does not obtain its general shape as a result of an initial shape of the pressing member used in step (b). In one embodiment step (a) provides the dental blank precursor with a shape that substantially corresponds to a proportionally enlarged shape of the dental blank. Further, step (b) may substantially proportionally (in three dimensions) reduce the dental blank precursor provided in step (a) in shape. For example, the dental blank precursor may be shaped generally cuboid in step (a). Then the cuboid shape may generally be maintained in step (b), but the length, width and height of the cuboid may be reduced proportionally. Other shapes, however, are possible like cylindrical shapes, or shapes having an elliptical or other suitable profile. Generally any such profile (including a rectangular and circular profile) may extend generally straight or curved to form the overall shape of the dental blank precursor and/or blank.

In one embodiment step (a) increases the material density of the bulk of ceramic particles used to form the dental blank precursor. Preferably step (a) increases the material density of a bulk of ceramic particles by a factor of between about 1.7 and 3, preferably by a factor of between about 2.2 and 2.3. The material density of the dental blank precursor of the ceramic particles is preferably between about 2.5 g/cm³ and 3.0 g/cm³, preferably about 2.9 g/cm³. In another embodiment step (a) increases the material density of a bulk of glass ceramic particles by a factor of between about 1.5 and 6.7, preferably by a factor of between about 2.9 and 3.1. The material density of the dental blank precursor of the glass ceramic particles is preferably between about 1.2 g/cm³ and 2.0 g/cm³, preferably about 1.5 g/cm³.

In another embodiment step (b) increases the material density of the dental blank relative to the dental blank precursor. Preferably step (b) increases the material density of the dental blank precursor of a ceramic material by a factor of between about 1.02 and 1.4, preferably by a factor of between about 1.08 and 1.1. The material density of the dental blank of a ceramic material is preferably between about 2.9 g/cm³ and 3.4 g/cm³, preferably about 3.15 g/cm³. In another embodiment step (b) increases the material density of the dental blank precursor of a glass-ceramic material by a factor of between about 1.02 and 1.9, preferably by a factor of between about 1.1 and 1.3. The material density of the dental blank of a glass-ceramic material is preferably between about 1.6 g/cm³ and 2.2 g/cm³, preferably about 1.7 g/cm³.

Other factors and densities are possible as appropriate for other materials used with the invention.

In another embodiment step (b) may be performed with a plurality of dental blank precursors generally simultaneously or in parallel. The step (b) may be performed generally simultaneously in the same press and/or in two or more presses. This may allow minimizing the cycle time required for pressing, for example. In one embodiment of the invention the method may comprise a step (c) of placing a plurality of dental blank precursors in different predetermined positions in a press. Dental blank precursors may, for example, be placed arranged in a generally two-dimensional pattern, for example side by side along two rows, on the pressing member.

In another embodiment of the invention at least two steps of the method of the invention are performed automated in a sequence. A preferred sequence of steps is step (a), and step (b), in the order as listed. Another sequence of steps may be step (a), step (c), and step (b), in the order as listed. The sequence of steps may also be repeated. A method of the invention may thus comprise:
repeatedly pressing ceramic particles to form blank precursors, and thereby forming a plurality of dental blank precursors in a sequential manner; and
pressing of the plurality of dental blank precursors in-parallel to form a plurality of dental blanks.

Such a method may be advantageous for concatenating a method step comprising uniaxial pressing with an a method step comprising isostatic pressing. For example, this may allow for concatenating an uniaxial press inline with an isostatic press in case one of the isostatic or uniaxial presses has a longer cycle time relative to the other.

In another embodiment the ceramic material has a relatively low content of binders, or is generally free of binders. Preferably the amount of binders is below 5% by weight, for example between about 2% to 4%. A ceramic material as it may be used with the invention may comprise between 90 and 99% by weight zirconium oxide, and preferably 91 to 97.25% by weight zirconium oxide. The ceramic material may further comprise 0-1% by weight aluminium oxide. The ceramic material may also be based on aluminium oxide, meaning the ceramic material may comprise 90 to 99% by weight aluminium oxide and 0 to 1% by weight zirconium oxide. Further, the ceramic material may comprise 0-10% by weight of at least one of hafnium oxide, yttrium oxide and oxides from gallium, germanium, and indium, as well as 0.0005 to 1.5% by weight of colouring additives, selected from the group consisting of the oxides Fe2O3, Er2O3 and/or MnO2. The ceramic material is preferably selected to be compatible for use in human bodies.

In another aspect the invention relates to an isostatic press for making a dental blank. The isostatic press comprises:
a first and a second pressing member that are shaped to form in cooperation a closed chamber for encasing a dental blank precursor; and
the pressing members being separable to provide the chamber to be opened.

Preferably the pressing members in the area in which they encase the dental blank are generally not supported by solid parts of the mold, in particular in a stage in which the pressing members are separated.

In one embodiment of the invention the first and second pressing members are flexible. Preferably one or both of the first and second pressing members have a thickness of between about 0.05 mm and 5 mm, preferably between about 0.05 mm and 0.10 mm.

In another embodiment the size and shape of the chamber generally corresponds to a cuboid having dimensions of between about between 10 mm×10 mm×10 mm and 30 mm×200 mm×200 mm, preferably between about 25 mm×25 mm×40 mm and 40 mm×25 mm×70 mm. The general size of the chamber may be provided mainly by a correspondingly sized receptacle in one of the first and the second pressing members, or by a correspondingly sized receptacle formed between both pressing members.

For example, the first pressing member may have a receptacle which is covered by the second pressing member when the first and second pressing members are combined. In this case, the first pressing member may have a receptacle of a generally cuboid shape, and the receptacle in size and shape may generally correspond to the size and shape of the chamber. Further, the corresponding second pressing member may be generally flat in at least an area covering the receptacle. Therefore a dental blank or blank precursor placed in the receptacle may be typically generally flush with the opening of the receptacle.

In another embodiment the first or the second pressing member may have a plurality of receptacles and the corresponding other pressing member may be generally flat in at least the areas covering the receptacles.

Further, the first and the second pressing members may have a first and second plurality of receptacles, respectively, with the first and second receptacles in combination forming chambers for encasing dental blank precursors. Therefore dental blanks or blank precursors received in the receptacles may project over the openings of the receptacles. This may provide the advantage of facilitating gripping of the blanks or blank precursors for insertion in or removal from the pressing members. This may be particularly advantageous if the press is used in an automated process.

In another embodiment the first and second pressing members encase a dental blank precursor. In this case preferably all sides of a dental blank precursor are surrounded by and in contact with the at least one of the first and second pressing members.

In another embodiment of the invention the press may be adapted to perform at least step (b) of the method of the invention.

Another aspect of the invention is related to a system for making dental blanks. The system comprises:
an isostatic press; and
an uniaxial press.

The system may further comprise a pick and place system for moving dental blank precursors between the isostatic press and the uniaxial press. Preferably, the pick and place system is adapted for moving dental blank precursors from the uniaxial press towards the isostatic press. The pick and place system thereby may also be indirectly coupled with one or both of the uniaxial and isostatic press. For example, the dental blank precursors may be stored in an output buffer associated or connected with the uniaxial press, and fed from the output buffer to the pick and place system. The pick and place system may then load the dental blank precursors into an input buffer associated or connected with the isostatic press. A system combining a uniaxial and a isostatic press may provide for an automated manufacturing of dental blanks. As an advantage the throughput of the manufacturing process may be maximized. Further, the automatic handling may provide for maximizing the hygiene during manufacturing of dental blanks because manual handling steps may be minimized. Such system may also allow for optimizing the cooperation of the two different pressing techniques according to the invention.

Still another aspect of the invention is related to a kit, comprising at least a part of an isostatic press, and instructions for connecting the isostatic press and an uniaxial press. This may provide for easy adaptation of an isostatic press with an uniaxial press, for example, to facilitate implementation of the method of the invention in a manufacturing plant for making dental blanks

### BRIEF DESCRIPTION OF THE DRAWINGS

The invention is described in the following by way of example only with reference to the accompanying figures, in which:

FIG. 1 is a perspective view of an uniaxial pressing tool which is filled with ceramic particles according to an embodiment of the invention;

FIG. 2 is a perspective view of an uniaxial pressing tool in which the ceramic particles are pressed according to an embodiment of the invention;

FIG. 3 is a perspective view of a dental blank precursor according to an embodiment of the invention;

FIG. 4 is a perspective view of a portion of an isostatic press with a pressing member holding a dental blank precursor according to an embodiment of the invention;

FIG. 5 is a perspective view of a portion of a pressing member holding a dental blank precursor according to an embodiment of the invention;

FIG. 6 is a perspective view of portions of two pressing members encasing a dental blank precursor according to an embodiment of the invention;

FIG. 7 is a perspective view of portions of two pressing members encasing a dental blank precursor according to an alternative embodiment of the invention;

FIG. 8 is a schematic cross-sectional view of an isostatic press according to an embodiment of the invention, when it is opened;

FIG. 9 is a schematic cross-sectional view of the press of FIG. 8 in when it is closed;

FIG. 10 is a schematic top view on the bottom part of the press of FIG. 8; and

FIG. 11 is a schematic view of an isostatic press having input and output stations according to an embodiment of the invention.

### DETAILED DESCRIPTION OF THE INVENTION

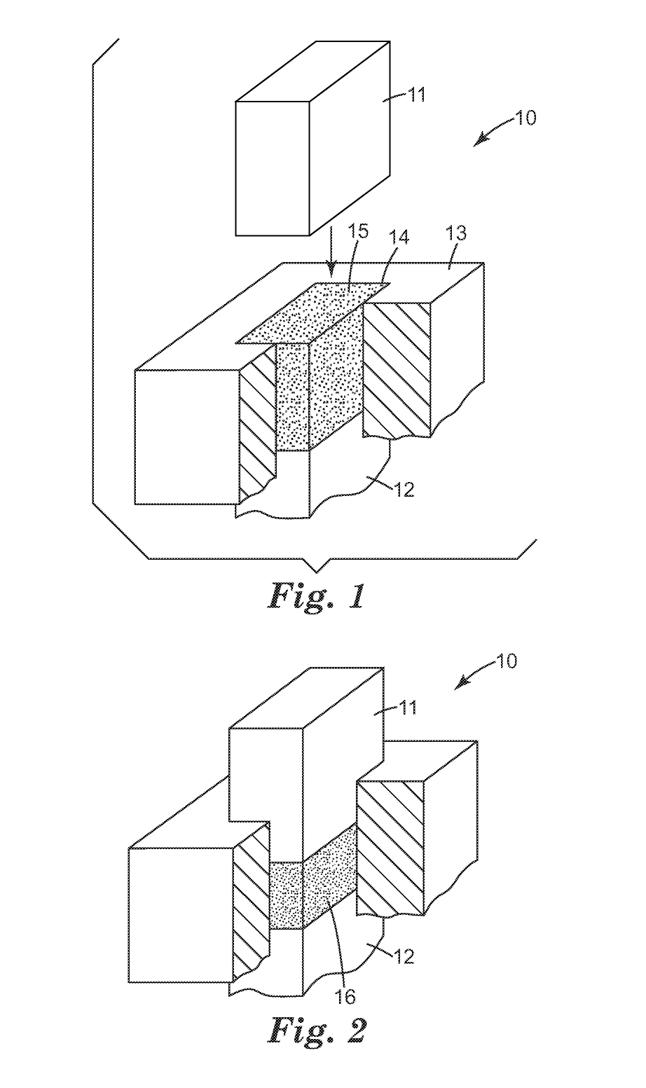

FIG. 1 shows a pressing tool 10 for uniaxial pressing of ceramic particles by way of example only. The pressing tool 10 has a lower pressing die 12 which is placed partially in a through-hole 14 of a die-plate 13. The die-plate 13 with its through-hole 14 thereby forms together with the lower pressing die 12 a receptacle. An upper pressing die 11 is positioned above the receptacle and leaves a space to the opening of the receptacle so that the receptacle is accessible for filling. The Figure shows the receptacle already filled with ceramic particles 15, for example with a ceramic powder. The example of FIG. 1 shows a tool as it is particularly used for preparing dental blank precursors of a generally cuboid shape, and has therefore a through-hole of a generally rectangular cross-section. Further, the opposing surfaces of the pressing dies 11, 12 are generally parallel to one another.

The terms “upper”, “lower”, “top” and “bottom” as they may be used to designate locations or parts in this specification are used for ease of explanation only. The so designated parts or locations may in other examples be arranged differently, for example at any angle or orientation, as appropriate.

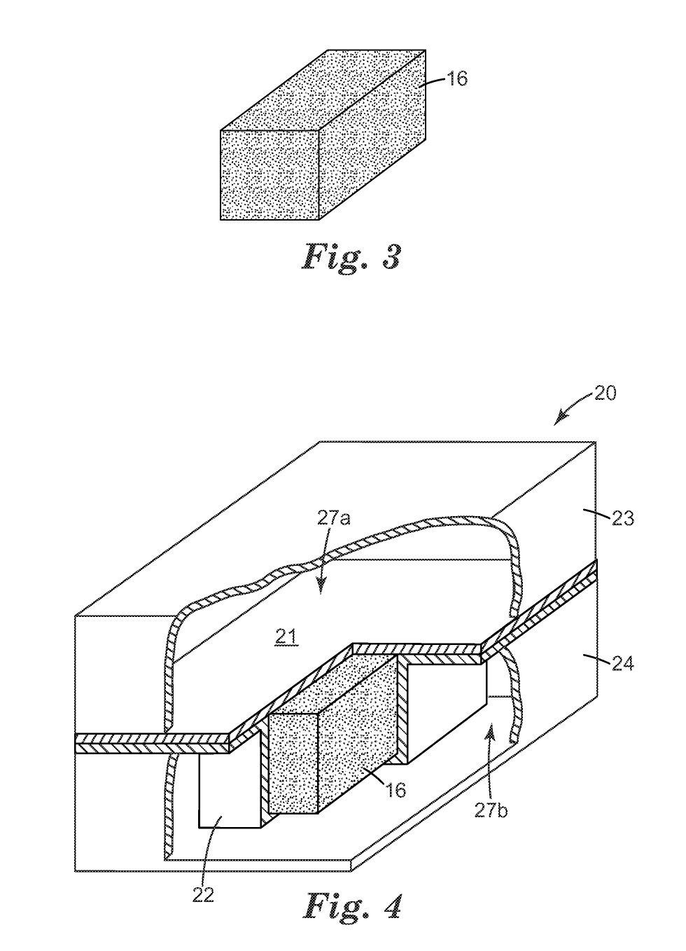

FIG. 2 shows the same pressing tool 10 as shown in FIG. 1, but with the upper pressing die 11 moved into the through-hole 14 (depicted in FIG. 1), and the lower pressing die 12 moved further in a direction towards the upper pressing die 11. The ceramic particles 15 (depicted in FIG. 1) are thus pressed between the upper and lower pressing dies 11, 12. Preferably, such pressing is performed at forces causing the ceramic particles to block with each other to a degree that provides the particles to form a generally solid body of material. The so formed body is shown in FIG. 3, and may be used as dental blank precursor 16 for further processing. Uniaxial pressing may comprises applying a pressure to a part or material to be pressed (for example the ceramic particles) of between about 10 MPa and 1000 MPa, in more particular between about 30 MPa and 150 MPa by a pressing die. Uniaxial pressing may be advantageous to manufacture dental blank precursors at relatively high automation level, and at relatively short cycle times.

In contrast to FIGS. 1 and 2, FIG. 4 shows a portion of an isostatic press 20. Generally isostatic presses use hydraulic fluids instead of pressing dies as used in uniaxial presses. Blanks pressed by isostatic processes are typically exposed to relatively isotropic pressing forces relative to generally parallel forces typically occurring in uniaxial processes. Therefore, depending on the type of process used for pressing, different inner material structures of the blank may be achieved. The isostatic press 20 of the example has an upper part 23 with an upper fluid chamber 27a, and a lower part 24 with a lower fluid chamber 27b. The fluid chambers 27a, 27b may be filled with a hydraulic fluid, such as hydraulic oil or an emulsion. In the example shown the fluid chambers 27a, 27b are closed by pressing members 21, 22, respectively. The press is openable between the pressing members 21, 22 for insertion of blanks or blank precursors in the press and removal from blanks or blank precursors from the press. Thereby the hydraulic fluid is kept encapsulated in the press. The pressing members 21, 22 further keep the blank separate from the hydraulic fluid. The press 20 in FIG. 4 is shown when it is closed, and a dental blank precursor 16 is encased between the pressing members 21, 22. The pressing members 21, 22 are preferably flexible. Therefore for pressing the dental blank precursor 16 the hydraulic fluid in the upper and lower chambers 27a, 27b may be pressurized, and the pressing members 21, 22 may transmit that pressure to the dental blank precursor 16.

For pressing the dental blank precursor 16 the fluid may preferably be pressurized to pressures of between about 10 MPa and 1000 MPa, in more particular between about 50 MPa and 700 MPa, preferably between about 100 MPa and 400 MPa.

As shown, the dental blank precursor 16 is almost entirely surrounded by the hydraulic fluid with only the relatively thin and flexible pressing members arranged between. Therefore the pressing forces arriving at the dental blank precursor are relatively isotropic. This may result in a relatively homogeneous inner material structure of the blank. In one embodiment of the invention the pressing members are considerably thinner than 30 mm, preferably between about 0.05 mm and 5 mm, and in particular preferably between about 0.05 mm and 0.10 mm. Preferably the flexibility of the pressing members is mainly provided by a relatively low thickness of the pressing members in relevant areas rather than by a soft material. Materials as they may be used for a pressing member are, for example polyurethane, polyethylene, polypropylene, but also rubbers, silicones, latex, thermoplastic elastomers, for example. Different materials may also be combined, for example layered. The pressing member may also comprise a coating providing for relatively low surface energy, for example a polytetrafluoroethylene coating. This may help to separate the blank form the pressing member.

The pressing members may comprise a reinforcement layer, for example a wire mesh. Such reinforcement layer is preferably provided in areas of the pressing member that are adapted to encase the blanks or blank precursors.

The pressing members 21, 22 in the example of FIG. 4 in combination form a structure resembling a bag which is part of the press. Such bag may be used multiple times in a continuous process. However, an alternative embodiment of the press (not shown) may have only one continuous larger fluid chamber in which a loose bag encasing a blank may be disposed freely movable. The bag in this case may be formed by sealing two pressing members to each other that are not parts of the press. This may for example be advantageous in case the pressing members are only made for single use, for example due to hygiene requirements applying for products obtained from the blanks.

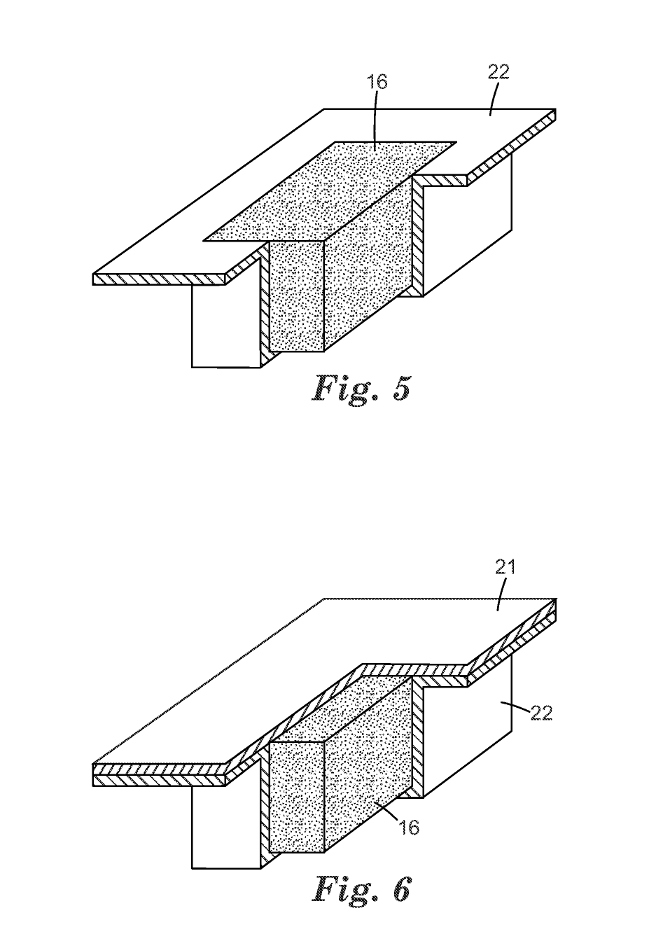

FIGS. 5 and 6 show the dental blank precursor 16 placed in a lower pressing member 22. FIG. 6 shows the embodiment of FIG. 5 with the dental blank precursor 16 covered by an upper pressing member 21. The upper and lower pressing members 21, 22 are preferably shaped so that they in cooperation form a closed chamber that generally corresponds in size and shape to the size and shape of the dental blank precursor 16. Therefore the pressing members 21, 22 are adapted to tightly encase the dental blank precursor 16 between each other. In the example shown in FIGS. 5 and 6 one part of the chamber is formed by a receptacle in the lower pressing member 22 that generally corresponds in size and shape to the size and shape of the dental blank precursor 16. Therefore dental blank precursor 16 may fit entirely in the receptacle of the lower pressing member 22, so that the upper surfaces of the blanks are flush with the opening of the receptacle of the pressing member 22 (shown in FIG. 5). On the other hand the upper pressing member 21 is generally flat and closes the receptacle to form the closed chamber.

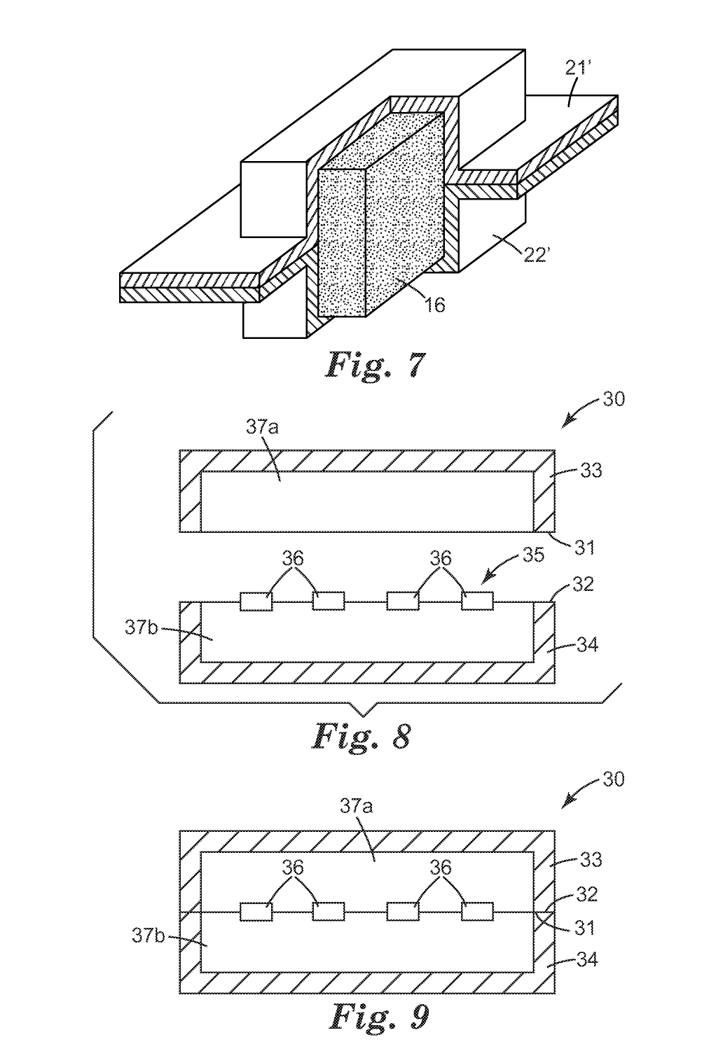

An alternative configuration of the pressing members is shown in FIG. 7. The pressing members 21′ and 22′ of FIG. 7 both have receptacles that together can form a closed chamber which generally corresponds in size and shape to the size and shape of the dental blank precursor 16. The depth of the receptacle in pressing member 22′ may be selected to provide the dental blank precursor or the dental blank to stick out sufficiently so that it can be grasped manually or automatically for handling. Such configuration may be advantageous for example to facilitate an automation of the dental blank making method. An appropriate configuration may be, for example, one in which the pressing members 21′, 22′ have receptacles of substantially equal depths. This may allow relatively easy insertion of the dental blank precursor in the lower pressing member 22′, and may provide for generally trouble free insertion in the upper pressing member 21′ when the pressing members are combined.

FIGS. 8 and 9 illustrate schematically an embodiment of a press 30 of the invention. The press 30 comprises an upper part 33, and a lower part 34. In FIG. 8, the press 30 is shown in its open state, whereas FIG. 9 shows the press 30 in its closed state.

The lower part 34 comprises a flexible pressing member 32 having a plurality of receptacles 35. Some of the receptacles 35 are illustrated as containing a dental blank precursor 36. The upper part 33 of the press 30 also comprises a flexible pressing member 31 which in this case is generally flat. The upper and lower pressing members 31, 32 when combined, as shown in FIG. 9, form several closed chambers each for encasing a dental blank precursor 36. However, as described for the embodiment shown in FIG. 7, both pressing members may have receptacles of smaller depths (not shown) that together form larger closed chambers as appropriate to encase dental blank precursors. The upper and lower parts 33, 34 have upper and lower fluid chambers 37a, 37b which in the example are closed by the upper and lower pressing members 31, 32.

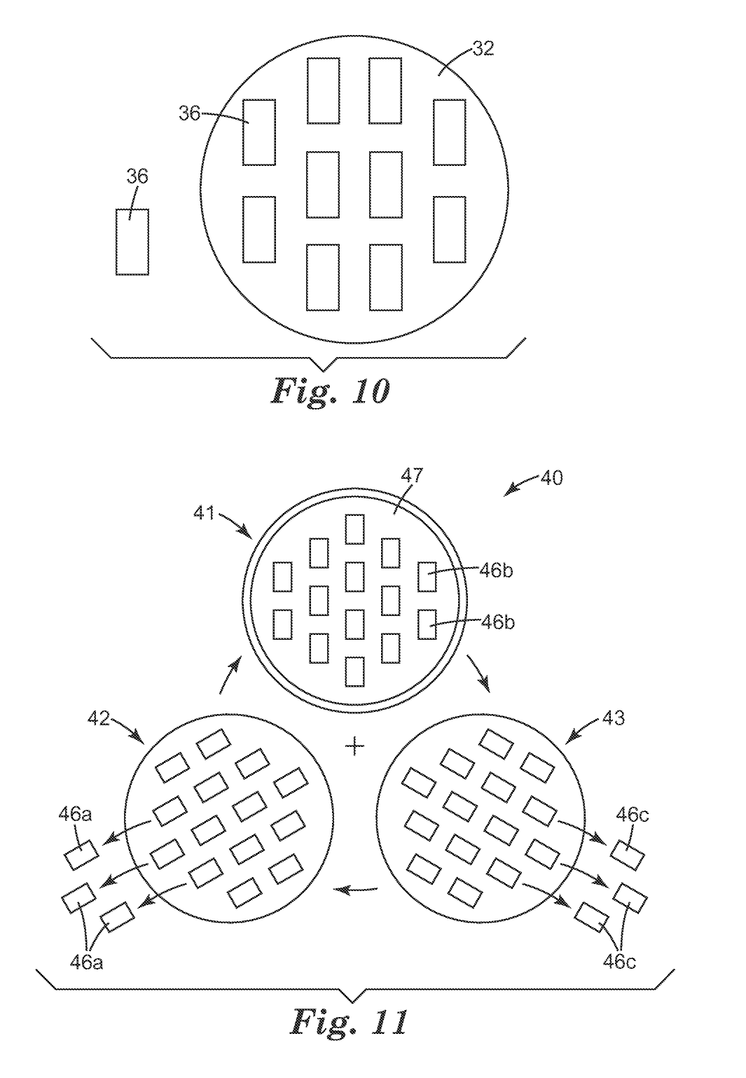

As shown in FIG. 10, several dental blank precursors, and the corresponding receptacles in the pressing members, may be arranged not only side by side, but also two-dimensionally spread over an area of the pressing member 32. This allows a relatively compact design of the press, and provides for a relatively high throughput of the process.

The dental blank precursors 36 may be loaded in the lower pressing member 32 automatically, for example by a pick and place system. The dental blank precursors 36 may be delivered from a previous manufacturing step to a pick up location from which they are picked up and placed in empty receptacles of the pressing member 32. After pressing of the dental blank precursors, the so formed dental blanks may be removed by the same or another pick and place system, and the receptacles may be filled again.

FIG. 11 shows a manufacturing line 40 having a press 41, an input station 42 and an output station 43. The press is configured to process a plurality of blanks in parallel. Therefore the press 41 may have a pressing member 47 in which several receptacles for receiving dental blank precursors 46b are arranged in a generally two-dimensional pattern. The press further has an input station 42 which can receive a plurality of dental blank precursors 46a in an arrangement that generally corresponds to the two-dimensional pattern provided in the pressing member 47. The press can process the plurality of dental blank precursors 46b, while in parallel the input station 42 may already be loaded with new dental blank precursors 46a. Because the pressing method on dental blank precursors 46b may require some time the input station may in the meantime be loaded, for example sequentially by a pick and place system. When the pressing process is finished the dental blank precursors 46a may all at once be charged in the press 41, for example by a multiple picker system. At the same time the press may be unloaded all at once, and the output transferred to the output station 43. The example shows dental blanks 46c which can be unloaded sequentially or in parallel from the output station 43. Unloading of the output station 43 may also happen in parallel to the pressing process and the loading of the input station 42. A cycle in which dental blanks are pressed, the input station is loaded, and the output station is unloaded may be repeated continuously. As an advantage such system may provide for a relatively high throughput because loading, unloading and pressing may be performed in a single cycle.

1. A method of making a dental blank, comprising the steps of:
(a) pressing ceramic particles to form a dental blank precursor; and
(b) pressing the dental blank precursor to form the dental blank, wherein one of the steps (a) and (b) includes uniaxial pressing and the other one of the steps (a) and (b) includes isostatic pressing.

2. The method of claim 1, wherein the step (b) includes isostatic pressing, with the dental blank precursor being in touch with a flexible pressing member.

3. The method of claim 2, wherein the pressing member is adapted to generally conform to the shape of at least a portion of the dental blank precursor and the shape of at least a portion of the dental blank.

4. The method of claim 1, wherein step (a) provides the dental blank precursor with a shape substantially corresponding to a proportionally enlarged shape of the dental blank.

5. The method of claim 1, wherein step (b) increases the material density of the dental blank relative to the dental blank precursor by between about 1.08 and 1.1.

6. The method of claim 5, further comprising a step of (c) placing a plurality of dental blank precursors in different predetermined positions in a press.

7. The method of claim 1, in which at least two steps are performed automated in a sequence, and wherein the sequence of the steps is (a), (c) and (b).

8. The method of claim 1, wherein the ceramic material comprises less than 5% of binders.

9. An isostatic press for making a dental blank, comprising:
a first and a second pressing member that are shaped to form in cooperation a closed chamber for encasing a dental blank precursor; and
the pressing members being separable to provide the chamber to be opened.

10. The press of claim 9, wherein the first and second pressing members are flexible, with one or both of the first and second pressing members having a thickness of between about 0.05 mm and 0.10 mm.

11. The press of claim 9, wherein the size and shape of the chamber generally corresponds to a cuboid having dimensions of between about 25 mm×25 mm×40 mm and 40 mm×25 mm×70 mm.

12. The press of claim 9, wherein the first pressing member has a receptacle which is covered by the second pressing member when the first and second pressing members are combined, and wherein the second pressing member is generally flat in at least an area covering the receptacle.

13. The press of claim 9, being adapted to perform at least step (b) of the method of claim 1.

14. A system for making dental blanks, comprising:
an isostatic press; and
an uniaxial press.

15. The system of claim 14, further comprising a pick and place system for moving dental blank precursors between the isostatic press and the uniaxial press.

16. A kit, comprising at least a part of an isostatic press, and instructions for connecting the isostatic press and an uniaxial press.
